(19) United States
(12) Patent Application Publication
(10) Pub. No.: US 2019/0295081 A1
(43) Pub. Date: Sep. 26, 2019

(54) System and Method for the Verification and Visualization of Subcomponents in a Product

(71) Applicant: Walmart Apollo, LLC, Bentonville, AR (US)

(72) Inventors: John Simon, Pembroke Pines, FL (US); Daniel Wayne Young, Rogers, AR (US); Jennifer Northrup, Eureka Springs, AR (US); Richard Carl McSorley, JR., Bentonville, AR (US); Joseph Jurich, JR., Molino, FL (US)

(21) Appl. No.: 16/361,879

(22) Filed: Mar. 22, 2019

Related U.S. Application Data
(60) Provisional application No. 62/647,142, filed on Mar. 23, 2018.

(51) Int. Cl. G06Q 20/40; G06F 16/27

(52) U.S. Cl. CPC G06Q 20/405; G06F 16/27

(57) ABSTRACT

A system and a method for the verification and visualization of subcomponents in a completed assembly is disclosed. The system receives upstream product component sourcing manifest from upstream source addresses. The system receives one or more downstream product component sourcing manifest from one or more downstream source addresses. The system generates a cryptographic verifiable ledger of transaction records based on the upstream and downstream manifests and upstream and downstream source addresses. The system propagates transaction records across a network. The system retrieves the records and instantiates a display tree graph structure based on the transactions in the master cryptographic ledger.

### RELATED APPLICATIONS

This application claim priority to, and the benefit of, U.S. Provisional Application No. 62/647,142, filed on Mar. 23, 2019, which is incorporated herein by reference in its entirety.

### BACKGROUND

Supply chain systems cannot accurately and reliably provide verification of components of a product as well as provide a customer facing visualization of components within a product.

### BRIEF DESCRIPTION OF DRAWINGS

Illustrative embodiments are shown by way of example in the accompanying drawings and should not be considered as a limitation of the present disclosure:

FIG. 1 is a block diagram illustrating a system for the verification and visualization of subcomponents in a product according to an exemplary embodiment.

FIG. 2A depicts an illustration of blocks as configured in accordance with an exemplary embodiment.

FIG. 2B depicts an illustration of transactions configured in accordance with an exemplary embodiment.

FIG. 3 depicts a flow diagram in accordance with an exemplary embodiment.

FIG. 4 depicts a process diagram as configured in accordance with an exemplary embodiment.

FIG. 5 depicts a system diagram configured in accordance with an exemplary embodiment.

FIG. 6 depicts a usage flow diagram for visualizing subcomponents in a product in accordance with an exemplary embodiment.

FIG. 7 depicts a tree structure for visualizing the subcomponents in a product in accordance with an exemplary embodiment.

FIG. 8 is a flow chart illustrating a process for verification and visualization of subcomponents in a product in accordance with an exemplary embodiment.

FIG. 9 depicts a block diagram of an exemplary computing device in accordance with an exemplary embodiment.

### DETAILED DESCRIPTION

Described in detail herein is a system that receives transactions of subcomponents and subassemblies of a product. The transactions are logged in a cryptographically verifiable ledger (also known as a blockchain). Through the logging of the transaction, and the utilization of fields within the transactions, an interactive display tree graph structure can be generated illustrating the composition of parts within the product and their relationship to the assembly process.

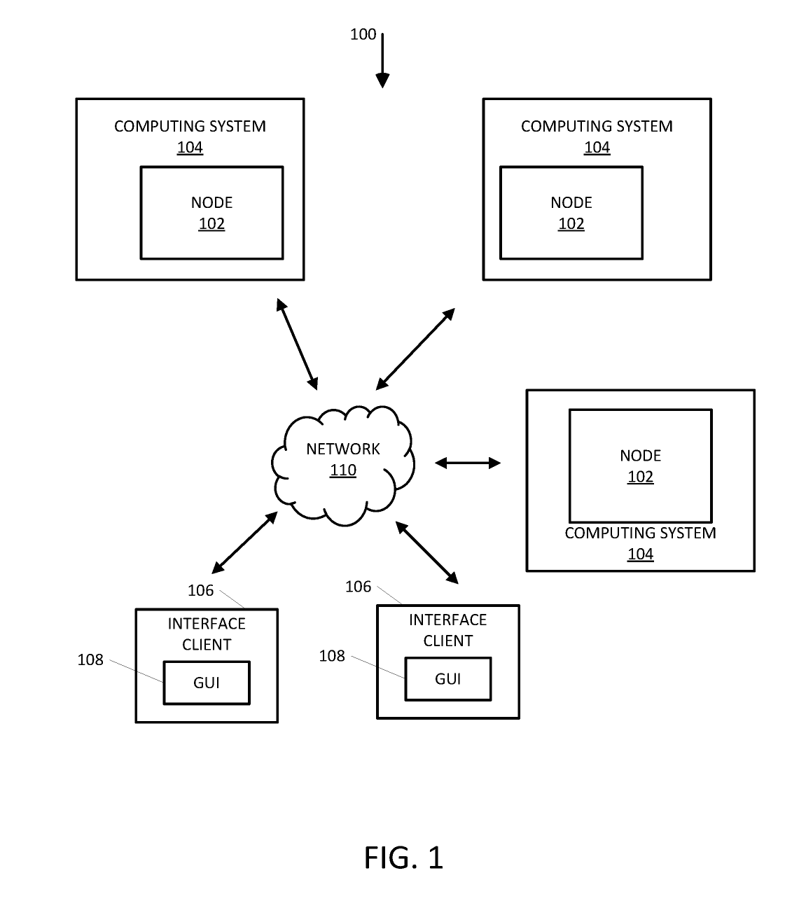

FIG. 1 is a block diagram illustrating a system for the verification and visualization of subcomponents in a product according to an exemplary embodiment. In the present example embodiment, the system 100 can include one or more computing systems 104, and one or more interface clients 106. The computing system 104 can be in communication with other computing systems and also with the one or more interface clients 106, via a communications network 110. The computing system 104 can include one or more nodes 102. Each of the one or more nodes 102 can store a copy of a master blockchain record and/or a shared ledger associated with events. The one or more nodes 102 can be configured to update the blocks in the master blockchain record based on the operation or transfer of one or more subcomponents in a product. The node 102 can store a copy of a sub blockchain record and/or a shared ledger, stored locally on the computing system 104.

In an example embodiment, one or more portions of the communications network 110 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each computing system 104 includes one or more computers or processors configured to communicate with other computing systems 104, and with the interface clients 106. The computing systems 104 can provide infrastructure to support the nodes 102. The storage infrastructure can be virtual or physical for the non-volatile storage of entries in the blockchain. The storage infrastructure may be abstracted from the computing system 104, wherein the node 102 interacts with the storage infrastructure without any knowledge of the underlying implementation. The nodes 102 can include a blockchain storage system that is configured to store a blockchain record or a shared ledger based on data that is affected by received events associated with physical objects. The blockchain storage system can be inclusive to the node, and implemented through the computing system 104. The node 102 can include a master blockchain. As a non-limiting example, the node 102 can store transaction records associated with physical objects such as invoices, purchase orders, inventory records, bills of materials, material origin information, sales/returns records, vendor orders, claims, shipping orders, and/or receiving orders relating to the one or more subcomponents that constitute a product. The computing system 104 can use the blocks of the blockchain to store transaction records associated with the events and to resolve data discrepancies between transactions relating to one or more subcomponents in a product. The computing system 104 can be located at one or more geographically distributed locations from each other. Alternatively, one or more virtualized computing systems 104 can be implemented within one physical computing system 104.

In a non-limiting embodiment, an interface client 106 can operate as the user-facing front end of the system. The interface client 106 can include one or more computers or processors configured to identify subcomponents of a product, and a display capable of rendering graphical objects pertaining to transactions in a blockchain storage system corresponding to the subcomponents in a product. The interface client 106 can provide complementary supporting infrastructure to interface with the network. The network interface can be an application programming interface (API) that defines how applications interact with other system components, including the network stack. Additionally, the interface client 106 can provide an API that defines how applications interact with display components. Display APIs can utilize well-defined constructs and interfaces for widget-based display items, for intuitive display of the graphical user interface 108.

A graphical user interface (GUI) 108 can be hosted on an interface client 106. The GUI 108 can communicate to other nodes 102 through APIs provided by the host interface client 106. As a part of the networking API, the host interface client 106 can provide a networking stack to interface and negotiate communication within the network 110. The GUI 108 can request information from a node 102 through the network 110 and the interface client 106. Additionally, a GUI 108 can implement additional features dependent on a blockchain implementation of the subcomponents of a product that are not inherent in the blockchain implementation itself. In a non-limiting example, features that a GUI 108 can implement include search functions, alerts based on subcomponent changes, and subcomponent preferences. The GUI 108 can visualize subcomponents of a product where the product is rendered as an aggregate of subcomponents in a display tree graph structure, where base components are leaves of the tree and the fully assembled product is the “root” of the tree. An additional embodiment can include ingredients in a food product.

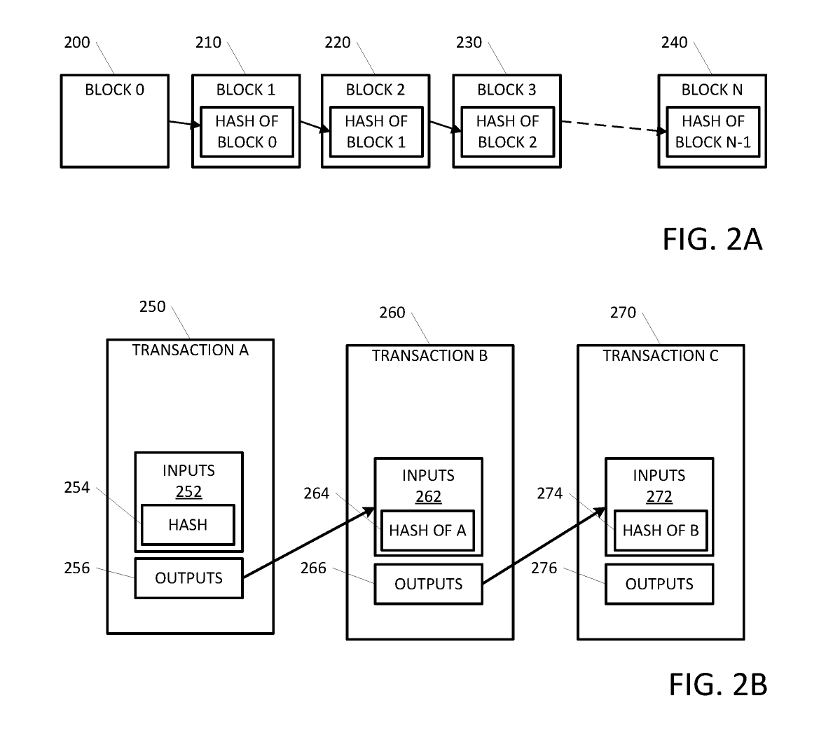

Referring to FIG. 2A, an illustration of a blockchain according to embodiments of the present disclosure is shown. A blockchain comprises a hash chain or a hash tree in which each block added in the chain contains a hash of the previous block. In FIG. 2A, block 0 200 represents a genesis block of the chain and can be generated in response to an event received associated with one or more subcomponents. The block 0 200 can include information associated with the event associated with the subcomponents, a hash key and a timestamp. The information associated with the event received associated with one or more subcomponents can include information associated with the subcomponents and information associated with the event, such as the delivery of the subcomponents, a quantity of the at least one subcomponents, name of the at least one subcomponents, type of the at least one subcomponents and size of the at least one subcomponents, and/or transfer of the ownership of subcomponents. Block 1 210 can be generated in response to a verification of the event. The block 1 210 can contain a hash of block 0 200. The block 1 210 can include the information associated with the event and the subcomponents. Otherwise, the block 1 210 can include information that an event was not verified. Additional blocks can be generated as additional requests are received and each block that is generated can include a hash of a previous block. For example, block 2 220 can be generated in response to a subsequent request and can contain a hash of block 1 210, block 3 230 can be generated in response to a yet another subsequent request and can contain a hash of block 2 220, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, the blocks generated by the nodes 102 in the computing systems 104 can contain rules and data for authorizing different types of actions and/or parties who can take action as described herein. In some embodiments, transaction and block forming rules may be part of the software algorithm on each node. When a new block is being formed, any node 102 on the system can use the prior records in the blockchain to verify whether the requested action is authorized. For example, a block may contain a public key associated with the user of a user device that receives the physical object, this design that allows the receiving user to capture a transfer of possession using a private key. Nodes 102 may verify that the user is in possession of the one or more subcomponents and/or is authorized to transfer the one or more subcomponents based on prior events when a block containing the transaction is being formed and/or verified. In some embodiments, rules themselves may be stored in the blockchain such that the rules are also resistant to tampering once created and hashed into a block. In some embodiments, the blockchain system may further include incentive features for nodes 102 that provide resources to form blocks for the chain. Nodes can compete to provide proof-of-work to form a new block, and the first successful node of a new block earns a reward.

Now referring to FIG. 2B, an illustration of blockchain-based transactions according to some embodiments is shown. In some embodiments, the blockchain illustrated in FIG. 2A comprises a hash chain protected by private/public key encryption. Transaction A 250 represents an event in a block of a blockchain showing a computing system creating a new block with transaction records associated with subcomponents, based on a received event. Transaction A 250 contains inputs 252 for the previous transaction and a hash 254 of a previous block. When the computing system 104 transmits an alert indicating an additional transaction involving subcomponents described as inputs to transaction A 250, a block containing transaction B 260 is formed. The inputs 262 can include a transactional signature of the previous transaction (outputs 256) as well as details of the transaction, and a hash 254 of the previous block. The record of transaction B 260 comprises inputs 262 in the form of the output 256 of transaction A, and a hash 264 of the previous block. The output 256 can comprise a cryptographical transactional signature Likewise, when the computing system 104 transmits another alert indicating an additional transaction involving subcomponents described as inputs to transaction B 260, a block containing transaction C 270 is formed. The inputs 272 for transaction C 270 are the outputs 266 from transaction B. A hash of B 274 as well as the outputs 266 of transaction B 260 is provided with the inputs 272. A transactional signature of transaction C 270 is provided as output 276, and subsequently as input into the next block. In some embodiments, more than one transaction can provide outputs 256, 266, 276 as inputs 252, 262, 272 into a subsequent block, thereby providing traceability between more than one previous subcomponent transaction into a subassembly transaction.

In some embodiments, when each event is created, the system may check previous events and the outputs and hashes to determine whether the transaction is valid. In some embodiments, transactions are broadcasted in the peer-to-peer network and each node on the system may verify that the transaction is valid prior to adding the block containing the current transaction to their copy of the blockchain. In some embodiments, nodes in the system may look for the longest chain in the system to determine the most up-to-date event to prevent the current owner from double spending the asset. The transactions in FIG. 2B are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

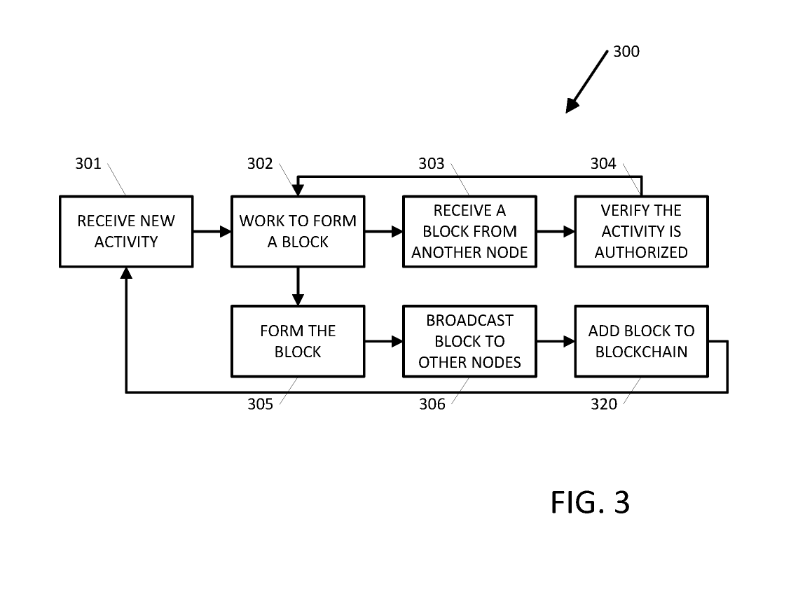

Now referring to FIG. 3, a flow diagram according to some embodiments is shown. In some embodiments, the steps shown in FIG. 3 may be performed by a computer system as described in FIG. 1, including multiple computing systems 104, and multiple nodes 102, and the like. In some embodiments, the steps in FIG. 3 may be performed by one or more of the nodes 102 in a system using blockchain for record keeping.

In step 301, a node receives a new activity in response to receiving an event associated with subcomponents. The new activity may comprise an update to the record being kept in the form of a blockchain with transaction records. In some embodiments, the new activity may be broadcasted to nodes on the network prior to step 301. For example, the nodes of different computing systems may be notified. In step 302, the node works to form a block to update the blockchain. In some embodiments, a block may comprise activities or updates and a hash of one or more previous blocks in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem or form a nonce in order to form a block. In some embodiments, the node may be configured to verify that the activity is authorized prior to working to form the block. In some embodiments, whether the activity is authorized may be determined based on records in the earlier blocks of the blockchain itself.

After step 302, if the node successfully forms a block in step 305 prior to receiving a block from another node, the node broadcasts the block to other nodes over the network in step 306. In step 320, the node then adds the block to its copy of the blockchain. In the event that the node receives a block formed by another node in step 303 prior to being able to form the block, the node works to verify that the activity (e.g., authentication of transfer) recorded in the received block is authorized in step 304. In some embodiments, the node may further check the new block against system consensus rules for blocks and activities to verify whether the block is properly formed. If the new block is not authorized, the node may reject the block update and return to step 302 to continue to work to form the block. If the new block is verified by the node, the node may express its approval by adding the received block to its copy of the blockchain in step 320. After a block is added, the node then returns to step 301 to form the next block using the newly extended blockchain for the hash in the new block.

In some embodiments, in the event one or more blocks having the same block number is received after step 320, the node may verify the later arriving blocks and temporarily store these blocks if they pass verification. When a subsequent block is received from another node, the node may then use the subsequent block to determine which of the received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 301.

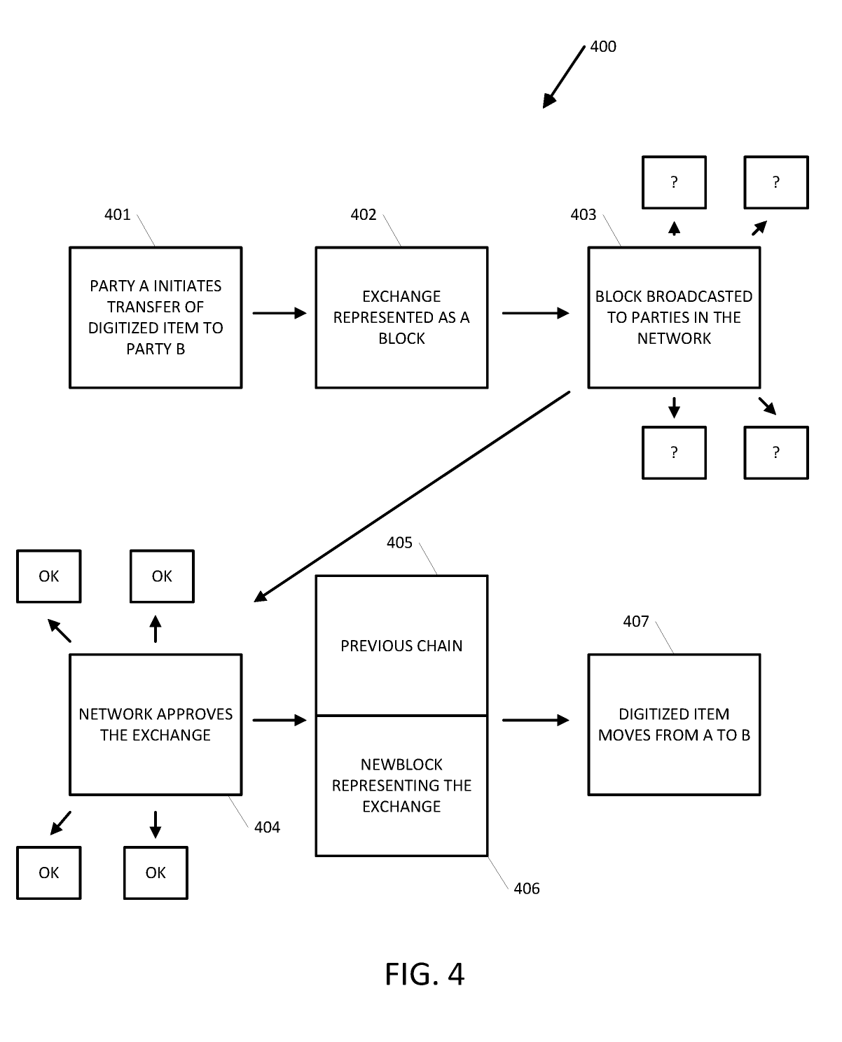

Now referring to FIG. 4, a process diagram, a blockchain update according to some implementations is shown. In step 401, party A (computing system 104) receives an event associated with subcomponents. In some embodiments, Party A may be authenticated by signing the transaction with an output in the previous transaction associated with the subcomponents. In step 402, the authentication initiated in step 401 is represented as a block. In some embodiments, the transaction may be compared with events in the longest chain in the distributed system to verify part A's authentication. In some embodiments, a plurality of nodes in the network may compete to form the block containing the authentication record. In some embodiments, nodes may be required to satisfy proof-of-work by solving a difficult mathematical problem to form the block. In some embodiments, other methods of proof such as proof-of-stake, proof-of-space, etc. may be used in the system. In step 403, the block is broadcasted to parties in the network. In step 404, nodes in the network authenticate party A by examining the block that contains the party A's authentication. In some embodiments, the nodes may check the solution provided as proof-of-work to approve the block. In some embodiments, the nodes may check the transaction against the event in the longest blockchain in the system to verify that the transaction is valid (e.g. party A is in possession of the object to be transferred). In some embodiments, a block may be approved with consensus of the nodes in the network. After a block is approved, the new block 406 representing the authentication is added to the existing chain 405 comprising blocks that chronologically precede the new block 406. The new block 406 may contain the transaction(s) and a hash of one or more blocks in the existing chain 405. In some embodiments, each node may then update their copy of the blockchain with the new block and continue to work on extending the chain with additional transactions. In step 407, when the chain is updated with the new block, the physical objects can be transferred from party A to party B (e.g., from the first mobile autonomous electronic device to the second autonomous electronic device).

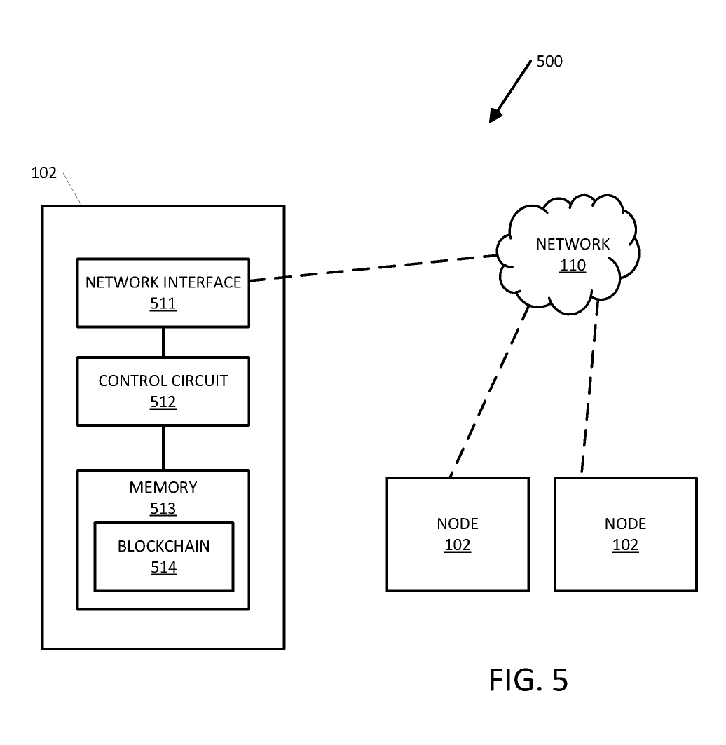

Now referring to FIG. 5, a system according to some embodiments is shown. A system for the verification and visualization of subcomponents in a product comprises a plurality of nodes 102 communicating over a network 110. In some embodiments, the nodes 102 may comprise a distributed blockchain server and/or a distributed timestamp server. Each node 102 in the system comprises a network interface 511, a control circuit 512, and a memory 513.

The control circuit 512 may comprise a processor, a microprocessor, and the like and may be configured to execute computer-readable instructions stored on a computer-readable storage memory 513. The computer-readable storage memory may comprise volatile and/or non-volatile memory and have stored upon it a set of computer-readable instructions which, when executed by the control circuit 512, causes the node 102 update the blockchain 514 stored in the memory 513 based on communications with other nodes 102 over the network 110. In some embodiments, the control circuit 512 may further be configured to extend the blockchain 514 by processing updates to form new blocks for the blockchain 514. Generally, each node may store a version of the blockchain 514, and together, may form a distributed database. In some embodiments, each node 102 may be configured to perform one or more steps described with reference to FIGS. 2-4 herein.

The network interface 511 may comprise one or more network devices configured to allow the control circuit to receive and transmit information via the network 110. In some embodiments, the network interface 511 may comprise one or more of a network adapter, a modem, a router, a data port, a transceiver, and the like. The network 110 may comprise a communication network configured to allow one or more nodes 102 to exchange data. In some embodiments, the network 110 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown, once a block is formed, the block cannot be changed without redoing the work to satisfy census rules thereby securing the block from tampering. A malicious attacker would need to provide proof standard for each block subsequent to the one he/she seeks to modify, race all other nodes and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the events are computationally impractical to reverse. As such, sellers are protected from fraud and buyers are protected by the routine escrow mechanism.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

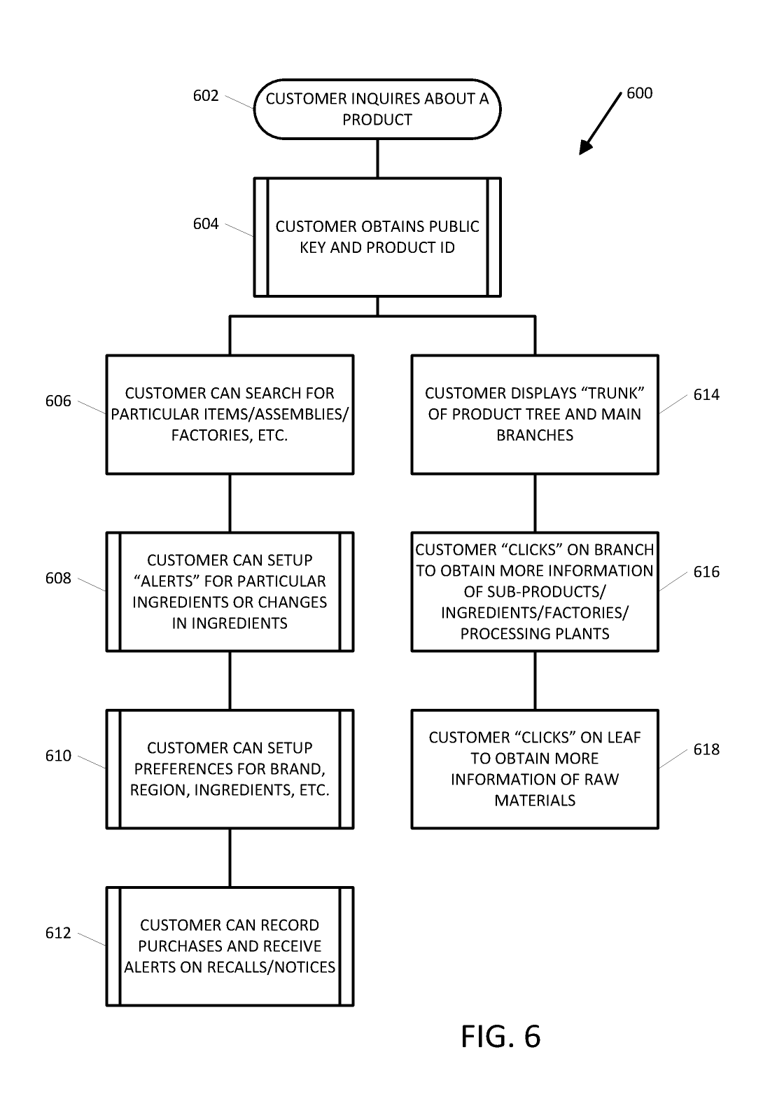

FIG. 6 depicts a usage flow diagram for visualizing subcomponents in a product in accordance with an exemplary embodiment.

The flow diagram 600 begins at step 602 with a user inquiring about a product. The user utilizes a GUI to display and interact with a parsed blockchain display tree graph structure. The product, its composition, and assembly process can be viewed and traversed through the GUI. The product can be something the user is interested in purchasing, has already purchased, sells, stores, transports, and the like. The product can be anything that has subcomponents or ingredients that make up a larger whole of the product.

At step 604, the user obtains public key and product identifier for the product. The public key and the product identifier correspond to sourcing information. The public key and product identifier can be part of a transaction record as written to a block in a blockchain.

At step 606, the user can search for particular items, assemblies, or factories. Utilizing the public key and the product identifier, the user can search a display tree graph structure determined by the relationship between transactions inherent to the blocks in the blockchain. The product identifier can locate particular items and assemblies within a parsed blockchain. The public key can locate particular factories or provide corresponding to upstream source address and downstream source addresses within a parsed blockchain display tree graph structure.

At step 608, the user can set up “alerts” for particular ingredients or changes in ingredients. The alerts can be created to correspond to particular public keys and product identifiers. Recalls alerts can be programmed as an event based on the correlation between product recalls, the providers, and the providers' corresponding public key. The public key can be identified within the parsed blockchain display tree graph structure with further differentiation by product identifier.

At step 610, the user can set up preferences for brand, region, and ingredients. Preferences for viewing items based on brand, region and ingredients can be facilitated by searching parsed blockchain display tree graph structure. Ingredients can correspond directly with transaction records in the blockchain, and can be determined by product identifiers. Brand preferences can be filtered by public keys corresponding to the subcontractors to the brand or the brand provider. Regional preferences may be filtered by inputs provided to the transaction record and filtered within the parsed blockchain display tree graph structure.

At step 612, the user can record purchases and receive alerts and recalls notices. As mentioned above, alerts and recall notices can be implemented through the parsing of the blockchain. The GUI can save a user transaction, including a public key and a product identifier for future retrieval. Additionally, the GUI, upon receiving a recall notification including a product identifier and a public key, queries the parsed blockchain display tree graph structure for each of the saved customer transactions. Upon the match of the recalled product identifier and the public key, the GUI can display a notification to the user that a previous purchase has been recalled.

At step 614, the user can display the “trunk” or “root” of product tree including main branches. The GUI can render the parsed blockchain display tree graph structure so that the user views a display tree graph structure with collapsible nodes. Each node in the tree corresponds to a component, subassembly or a final product. The “trunk” or “root” of the tree corresponds to the final product assembly.

At step 616, the user, through the GUI, clicks on a branch to obtain more information of sub-products, ingredients, factories and processing plants. The GUI displays information from the display tree graph structure as the user traverses the display tree graph structure. Adjacent vertical nodes correspond to aggregates of components. The further the user navigates away from the root, the decomposition of the final product becomes more pronounced.

At step 618, the user, through the GUI, clicks on a leaf to obtain more information of raw materials. The leaf nodes are the most granular nodes on the display tree graph structure. The components of the leaf nodes correspond to the smallest trackable part of the final product.

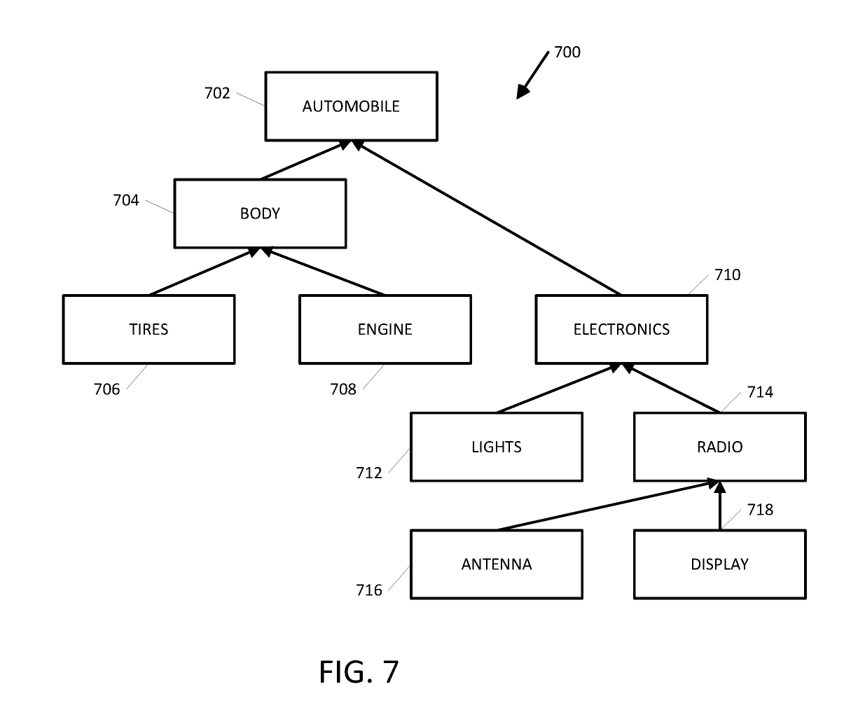

FIG. 7 depicts a display tree graph structure that can be rendered in a graphical user interface (GUI) for visualizing the subcomponents in a product in accordance with an exemplary embodiment.

As related transactions are extracted from the blockchain blocks, a tree can be formed. The trunk or root 702 of the tree may be represented as the most recent transaction in the blockchain. The root 702 can correspond to the final product from the subcomponents stored as transactions in the block chain. In the illustrated example, the root 702 is a fully assembled automobile. In the GUI illustrating the tree, focus can be given to the root 702, by a user action such as a mouse click, to provide additional information about the root 702. Additional user action can provide expansion or collapse of the tree either revealing additional information about adjacent tree nodes or hiding additional information about adjacent tree nodes.

Adjacent to the root 702 are branches 704, 710, 714. Branches 704, 710, 714 can be representative of subcomponents or subassemblies. The branches 704, 710, 714 are transactions that occur within the block chain prior to the creation of the root 702 block. Branch 704, 710, 714 transactions outputs provide inputs into the root 702 node block or into other branch 704, 710, 714 blocks, so the subcomponent path through the blockchain can be traced and visualized. In a GUI illustrating the tree, focus can be given to the branches 704, 710, 714, by a user action such as a mouse click, to provide additional information about the branches 704, 710, 714. Additional information can be extracted from transactions in the blockchain to describe the subcomponents or subassemblies and their relationship to the root 702 and the leaves 706, 708, 712, 716, 718, upon additional user interaction.

Terminal nodes from preceding nodes (root 702, or branch 704, 710, 714) are leaves 706, 708, 712, 716, 718. Leaf 706, 708, 712, 716, 718 nodes correspond to subcomponents that are the most basic of the final assembly that are represented by the root 702. The leaves 706, 708, 712, 716, 718 generally are the smallest subcomponent that can properly tracked by blockchain transactions. A leaf on the display tree graph structure can correspond to a single subcomponent type. In a GUI illustration the tree, focus can be given to the leaves 706, 708, 712, 716, 718 by a user action such as a mouse click, to provide additional information about the leaves 706, 708, 712, 716, 718. The additional information can describe the subcomponent represented by the leaf node, and its relation to the attached branch(es) and root nodes.

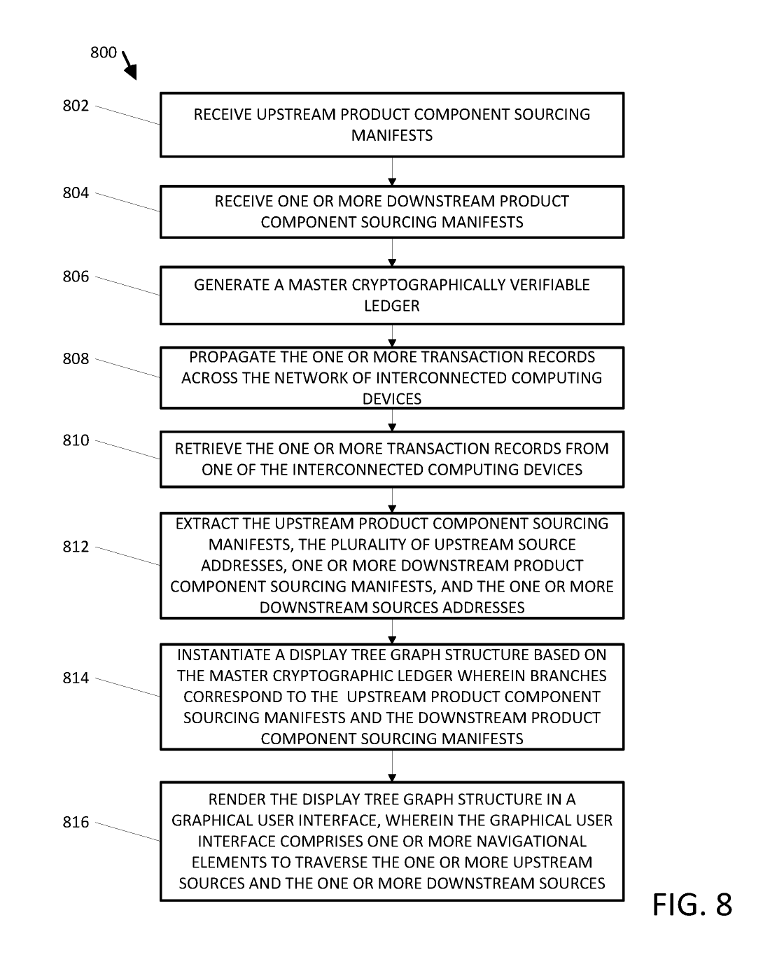

FIG. 8 is a flow chart illustrating a process for verification and visualization of subcomponents in a product in accordance with an exemplary embodiment.

At step 802, a node receives upstream product component sourcing manifests. The upstream product component sourcing manifests can include components and subcomponents in an assembly as the subject of a transaction between vendors. The manifests can include details relating to the nature and number of components in the transaction as well as identifying the participants in the transaction. The participants in the transaction can have unique disparate upstream sources addresses that correspond to the providers of the subcomponents for a completed assembly.

At step 804, the node receives one or more downstream product component sourcing manifests from one or more downstream source addresses. The manifests can include details relating to the nature and number of components in the transaction as well as identifying the participants in the transaction. The participants in the transaction can have unique disparate downstream sources addresses that correspond to the receivers of the subcomponents for a completed assembly. Both the upstream product component sourcing manifests and the downstream product component sourcing manifests can include product information including units, price, and manufacturer.

At step 806, the node generates a master cryptographically verifiable ledger represented by a sequence of blocks. Each block can contain one or more transaction records with each subsequent block containing a hash value associated with the previous block. Each of the transaction records can include the upstream product component sourcing manifests, the plurality of disparate upstream source addresses, one or more downstream product component sourcing manifests, and the one or more downstream source addresses. The transaction records can also include transaction times, confirmation signatures, and product identifiers.

At step 808, the node propagates the one or more transaction records across the network of interconnected computing devices. Each of the computing devices maintains a copy of the one or more transaction records. The transaction records are kept synchronized across the network of interconnected computing devices as described above, in relation to FIG. 3.

At step 810, the GUI retrieves the one or more transaction records from one of the interconnected computing devices. The interface client establishes a connection to the network of interconnected computing devices, and provides an interface for the GUI to interact with the one or more transaction records. The GUI can retrieve and parse each transaction in the blockchain. The GUI can identify relationships between the transactions by examining the upstream product component sourcing manifests, the plurality of disparate upstream source addresses, one or more downstream product component sourcing manifests, and the one or more downstream source addresses.

At step 812, the GUI extracts the upstream product component sourcing manifests, the plurality of upstream source addresses, one or more downstream product component sourcing manifests, and the one or more downstream sources addresses. The GUI extracts the information out of the transaction record utilizing a parser. The GUI creates a data structure in the computer memory of the interface client to capture the parsed information from the transaction record.

At step 814, the GUI instantiates a display tree graph structure based on the linear sequence of blocks in the master cryptographic ledger. The branches correspond to the upstream product component sourcing manifests correlated with the plurality of disparate upstream source addresses and the downstream product component sourcing manifests correlated with the one or more downstream source addresses. The GUI builds relationships between the parsed transaction records based on the upstream and downstream source addresses. Additionally, the source manifests identify the nature of the relationships between the nodes within the display tree graph structure.

At step 816, the GUI renders the display tree graph structure in a graphical user interface. The graphical user interface includes one or more navigational elements to traverse the one or more upstream sources and the one or more downstream sources. The GUI can update the display tree graph structure based on an input of a public key and a product identifier. The GUI can update the display tree graph structure to render the branches with visual indications corresponding to a product recall. The visual indications can correspond to one or more components present in the upstream product component sourcing manifests and the downstream product component sourcing manifests.

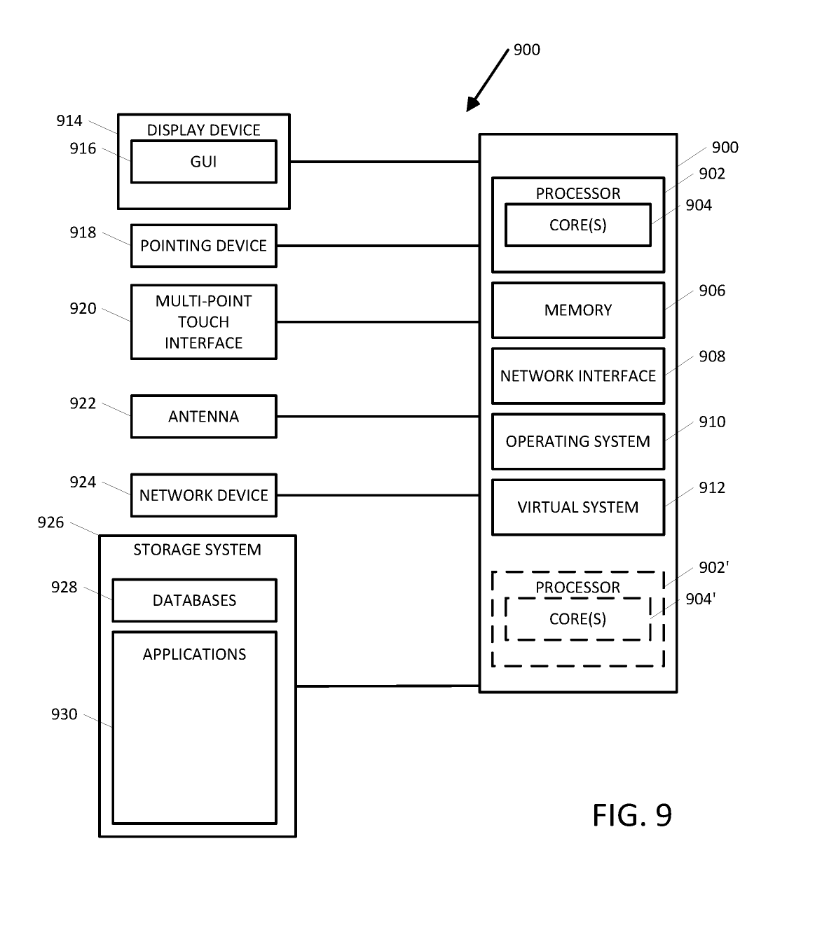

FIG. 9 is a block diagram of an example computing device for implementing exemplary embodiments of the present disclosure. Embodiments of the computing device 900 can implement embodiments of the system for verification and visualization of subcomponents in a product. For example, the computing device can be embodied as a portion of the computing system, and interface clients. The computing device 900 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 906 included in the computing device 900 may store computer-readable and computer-executable instructions or software (e.g., applications 930 such as the GUI 108) for implementing exemplary operations of the computing device 900. The computing device 900 also includes configurable and/or programmable processor 902 and associated core(s) 904, and optionally, one or more additional configurable and/or programmable processor(s) 902′ and associated core(s) 904′ (for example, in the case of computer systems having multiple processors/cores), for executing computer-readable and computer-executable instructions or software stored in the memory 906 and other programs for implementing exemplary embodiments of the present disclosure. Processor 902 and processor(s) 902′ may each be a single core processor or multiple core (904 and 904′) processor. Either or both of processor 902 and processor(s) 902′ may be configured to execute one or more of the instructions described in connection with computing device 900.

Virtualization may be employed in the computing device 900 so that infrastructure and resources in the computing device 900 may be shared dynamically. A virtual machine 912 may be provided to handle a process running on multiple processors so that the process appears to be using only one computing resource rather than multiple computing resources. Multiple virtual machines may also be used with one processor.

Memory 906 may include a computer system memory or random access memory, such as DRAM, SRAM, EDO RAM, and the like. Memory 906 may include other types of memory as well, or combinations thereof. The computing device 900 can receive data from input/output devices. A user may interact with the computing device 900 through a visual display device 914, such as a computer monitor, which may display one or more graphical user interfaces 916, multi touch interface 920 and a pointing device 918.

The computing device 900 may also include one or more storage devices 926, such as a hard-drive, CD-ROM, or other computer-readable media, for storing data and computer-readable instructions and/or software that implement exemplary embodiments of the present disclosure (e.g., GUI 108). For example, exemplary storage device 926 can include one or more databases 928 for storing information associated with one or more subcomponents and events associated with the one or more subcomponents. The databases 928 may be updated manually or automatically at any suitable time to add, delete, and/or update one or more data items in the databases.

The computing device 900 can include a network interface 908 configured to interface via one or more network devices 924 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 922 to facilitate wireless communication (e.g., via the network interface) between the computing device 900 and a network and/or between the computing device 900 and other computing devices. The network interface 908 may include a built-in network adapter, network interface card, PCMCIA network card, card bus network adapter, wireless network adapter, USB network adapter, modem or any other device suitable for interfacing the computing device 900 to any type of network capable of communication and performing the operations described herein.

The computing device 900 may run any operating system 910, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 900 and performing the operations described herein. In exemplary embodiments, the operating system 910 may be run in native mode or emulated mode. In an exemplary embodiment, the operating system 910 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps can be replaced with a single element, component, or step Likewise, a single element, component, or step can be replaced with multiple elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

We claim:

1. A system for verification and visualization of subcomponents in a product comprising:
a network of interconnected computing devices, wherein the interconnected computing devices are configured to:
receive upstream product component sourcing manifests from a plurality of disparate upstream source addresses,
receive one or more downstream product component sourcing manifests from one or more downstream sources addresses,
generate a master cryptographically verifiable ledger represented by a sequence of blocks, each block containing one or more transaction records and each subsequent block containing a hash value associated with the previous block, wherein each of the transaction records comprises the upstream product component sourcing manifests, the plurality of disparate upstream source addresses, one or more downstream product component sourcing manifests, and the one or more downstream source addresses;
propagate the one or more transaction records across the network of interconnected computing devices, wherein each of the computing devices maintains a copy of the one or more transaction records;
an interfacing electronic device, configured to:
establish a connection with the network of interconnected computing devices,
retrieve the one or more transaction records from one of the interconnected computing devices,
extract the upstream product component sourcing manifests, the plurality of upstream source addresses, one or more downstream product component sourcing manifests, and the one or more downstream sources addresses;
instantiate a display tree graph structure based on the linear sequence of blocks in the master cryptographic ledger wherein branches correspond to the upstream product component sourcing manifests correlated with the plurality of disparate upstream source addresses and the downstream product component sourcing manifests correlated with the one or more downstream source addresses, and
render the display tree graph structure in a graphical user interface, wherein the graphical user interface comprises one or more navigational elements to traverse the one or more upstream sources and the one or more downstream sources.

2. The system of claim 1, wherein the plurality of disparate upstream source addresses correspond to providers of subcomponents for a completed assembly.

3. The system of claim 1, further comprising updating the display tree to render the branches with visual indications corresponding to a product recall of one or more components present in the upstream product component sourcing manifests and the downstream product component sourcing manifests.

4. The system of claim 1, wherein the upstream product component sourcing manifests and the downstream product component sourcing manifests comprise product information including units, price, and manufacturer.

5. The system of claim 1, wherein the each of the transaction records further comprises transaction times, confirmation signatures, and product identifiers.

6. The system of claim 1, wherein a leaf on the display tree corresponds to a single subcomponent type.

7. The system of claim 1, wherein the graphical user interface updates the display tree graph structure based on an input of a public key and a product identifier.

8. A method for the verification and visualization of subcomponents in a product comprising:
receiving upstream product component sourcing manifests from a plurality of disparate upstream source addresses,
receiving one or more downstream product component sourcing manifests from one or more downstream source addresses,
generating a master cryptographically verifiable ledger represented by a sequence of blocks, each block containing one or more transaction records and each subsequent block containing a hash value associated with the previous block, wherein each of the transaction records comprises the upstream product component sourcing manifests, the plurality of disparate upstream source addresses, one or more downstream product component sourcing manifests, and the one or more downstream source addresses,
propagating the one or more transaction records across the network of interconnected computing devices, wherein each of the computing devices maintains a copy of the one or more transaction records,
establishing a connection, by an interfacing electronic device to the network of interconnected computing devices,
retrieving the one or more transaction records from one of the interconnected computing devices,
extracting the upstream product component sourcing manifests, the plurality of upstream source addresses, one or more downstream product component sourcing manifests, and the one or more downstream sources addresses,
instantiating a display tree graph structure based on the linear sequence of blocks in the master cryptographic ledger wherein branches correspond to the upstream product component sourcing manifests correlated with the plurality of disparate upstream source addresses and the downstream product component sourcing manifests correlated with the one or more downstream source addresses, and
rendering the display tree graph structure in a graphical user interface, wherein the graphical user interface comprises one or more navigational elements to traverse the one or more upstream sources and the one or more downstream sources.

9. The method of claim 8, wherein the plurality of disparate upstream sources correspond to providers of subcomponents for a completed assembly.

10. The method of claim 8, further comprising updating the display tree to render the branches with visual indications corresponding to a product recall of one or more components present in the upstream product component sourcing manifests and the downstream product component sourcing manifests.

11. The method of claim 8, wherein the upstream product component sourcing manifests and the downstream product component sourcing manifests comprise product information including units, price, and manufacturer.

12. The method of claim 8, wherein each of the transaction record further comprises transaction times, confirmation signatures, and product identifiers.

13. The method of claim 8, wherein a leaf on the display tree corresponds to a single subcomponent type.

14. The method of claim 8, wherein the graphical user interface updates the display tree graph structure based on an input of a public key and a product identifier.

15. A non-transitory computer-readable medium for the verification and visualization of subcomponents in a product, having stored thereon, instructions that when executed in a computing system, cause the computing system to perform operations comprising:
receiving upstream product component sourcing manifests from a plurality of disparate upstream source addresses,
receiving one or more downstream product component sourcing manifests from one or more downstream source addresses,
generating a master cryptographically verifiable ledger represented by a sequence of blocks, each block containing one or more transaction records and each subsequent block containing a hash value associated with the previous block, wherein each of the transaction records comprises the upstream product component sourcing manifests, the plurality of disparate upstream source addresses, one or more downstream product component sourcing manifests, and the one or more downstream source addresses;
propagating the one or more transaction records across the network of interconnected computing devices, wherein each of the computing devices maintains a copy of the one or more transaction records,
establishing a connection, by an interfacing electronic device to the network of interconnected computing devices,
retrieving the one or more transaction records from one of the interconnected computing devices,
extracting the upstream product component sourcing manifests, the plurality of upstream source addresses, one or more downstream product component sourcing manifests, and the one or more downstream sources addresses,
instantiating a display tree graph structure based on the linear sequence of blocks in the master cryptographic ledger wherein branches correspond to the upstream product component sourcing manifests correlated with the plurality of disparate upstream source addresses and the downstream product component sourcing manifests correlated with the one or more downstream source addresses, and
rendering the display tree graph structure in a graphical user interface, wherein the graphical user interface comprises one or more navigational elements to traverse the one or more upstream sources and the one or more downstream sources.

16. The computer-readable medium of claim 15, wherein the plurality of disparate upstream sources correspond to providers of subcomponents for a completed assembly.

17. The computer-readable medium of claim 15, further comprising updating the display tree to render the branches with visual indications corresponding to a product recall of one or more components present in the upstream product component sourcing manifests and the downstream product component sourcing manifests.

18. The computer-readable medium of claim 15, wherein the upstream product component sourcing manifests and the downstream product component sourcing manifests comprise product information including units, price, and manufacturer.

19. The computer-readable medium of claim 15, wherein a leaf on the display tree corresponds to a single subcomponent type.

20. The computer-readable medium of claim 19, wherein the graphical user interface displays characteristics of the single subcomponent type corresponding to the leaf on the display tree.
